(19) United States
(12) Patent Application Publication
(10) Pub. No.: US 2008/0297925 A1
(43) Pub. Date: Dec. 4, 2008

(54) CAMERA MODULE

(75) Inventors: YING-LIN CHEN, Tu-Cheng (TW); YUNG-CHOU CHEN, Tu-Cheng (TW); WEN-CHANG CHEN, Tu-Cheng (TW); SU-JEN CHENG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/950,384

(22) Filed: Dec. 4, 2007

(30) Foreign Application Priority Data
Jun. 4, 2007 (CN) 200710200751.8

(51) Int. Cl. G02B 7/02; H04N 5/225

(52) U.S. Cl. 359/829; 348/360; 348/E05.022

(57) ABSTRACT

An exemplary camera module includes a lens module and a lens holder. The lens module is coupled with the lens holder using threads. The thread coupling section between the lens module and the lens holder is filled with a damping oil for sealing the thread coupling section.

### BACKGROUND

1. Technical Field

The invention relates to image technology and, particularly, relates to a camera module.

2. Description of Related Art

A typical camera module includes a lens holder, and a lens module coupling with the lens holder using threads. This thread coupling way may cause problems: (1) Optical members of the camera module may be contaminated by scraps scratched from the thread coupling section formed between the lens module and the lens holder when the camera module is being assembled (i.e., screwed the lens module into the lens holder); and (2) Sealing of the camera module is less than optimal since the thread coupling section should leave a spatial tolerance to allow a screwing operation on the lens module/lens holder, therefore, the optical members accommodated within the camera module is readily damaged by an inleak water vapor through the spatial tolerance.

Therefore, it is desirable to provide a camera module, which can overcome the abovementioned problems.

### SUMMARY

In a present embodiment, a camera module comprises a lens module, and a lens holder. The lens module is coupled with the lens holder using threads. The thread coupling section formed between the lens module and the lens holder is filled with a damping oil for sealing the thread coupling section.

### BRIEF DESCRIPTION OF THE DRAWINGS

Many aspects of the present camera module should be better understood with reference to the following drawings. The components in the drawings are not necessarily drawn to scale, the emphasis instead being placed upon clearly illustrating the principles of the present camera module. Moreover, in the drawings, like reference numerals designate corresponding parts throughout the several views.

FIG. 1 is a schematic, cross-sectional view of a camera module, according to a first embodiment; and

FIG. 2 is a schematic, cross-sectional view of a camera module, according to a second embodiment.

### DETAILED DESCRIPTION OF THE EMBODIMENTS

Embodiments of the present camera module will now be described in detail with the references to the drawings.

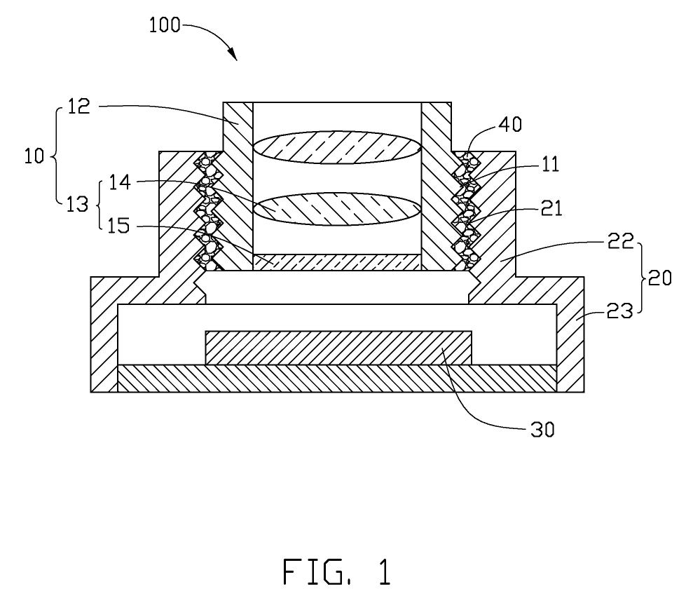

Referring to FIG.1, a camera module 100, according to a first embodiment, includes a lens module 10, a lens holder 20, and a light-receiving member 30. The lens module 10 is coupled with the lens holder 20 using threads. The thread coupling section between the lens module 10 and the lens holder 20 is filled with a damping oil 40. The light-receiving member 30 is disposed in the lens holder 20, opposing/facing the lens module 10 for receiving light through the lens module 10.

Specifically, the lens module 10 defines an external thread section 11, and the lens holder 20 defines an internal thread section 21 coupling with the external thread section 11. The lens module 10 is installed in the lens holder 20 by screwing the external thread section 11 into the internal thread section 21. More specifically, the lens module 10 includes a lens barrel 12, and the lens holder 20 includes a cylindrical/tubular barrel-receiver 22. The lens barrel 12 has an outer diameter essentially equal to an inner diameter of the barrel-receiver 22. The external thread section 11 is defined in the outer surface of the lens barrel 12, and the internal thread section 21 is defined in the inner surface of the barrel-receiver 22.

In addition to the lens barrel 12, the lens module 10 further includes at least one optical member 13, such as imaging lens or color filter, accommodated in the lens barrel 12. In this illustrated embodiment, the lens module 10 includes two imaging lenses 14 and an infrared cut filter 15. The two imaging lenses 14 and the infrared cut filter 15 are arranged in this order from the object side to the image side of the camera module 100. The imaging lens 14 is, beneficially, a glass aspheric lens for improving an imaging quality of the camera module 100, but could alternatively take the form of, e.g., glass spheric lens, plastic aspheric lens or plastic spheric lens (for improving the imaging quality or reducing a production cost). Except the barrel-receiver 22, the lens holder 20 can further include a square base 23 for receiving the light-receiving member 40.

Alternatively, the lens module 10 can employ just one lens to reduce the cost or can employ more than two lenses to improve the imaging quality of the lens module 100. Additionally, the infrared cut filter 15 can be received in the base 23 acting as an encapsulation of the light-receiving member 30, instead of being received in the lens barrel 12.

The light-receiving member 30 can be a charge-coupled device (CCD), or a complementary metal oxide semiconductor (CMOS) device.

Employed damping oil 40, a scraping motion between the external thread section 11 and the internal thread section 21 is avoided. The optical members (e.g., the light-receiving member 30 or the imaging lens 14) are shielded from being contaminated by scraps produced by the scratching motion. Additionally, the damping oil 40 seals the thread coupling section formed between the external thread section 11 of the lens 10 and the internal thread section 21 of the lens holder 20, thus, sealing of the camera module 100 is improved. The optical members are hermetically encapsulated and are protected in the camera module 100.

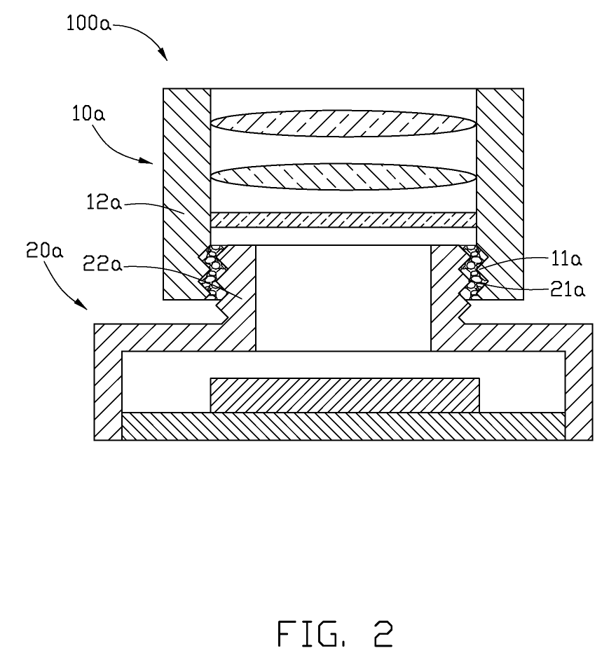

Referring to FIG. 2, a camera module 100a, according to a second embodiment, is shown. The camera module 100a is essentially similar to the camera module 100 except with respect to the thread sections.

In this illustrated embodiment, the lens barrel 12a has an inner diameter essentially equal to an outer diameter of the barrel-receiver 22a. The lens barrel 12a defines an internal thread section 11a in the inner surface thereof, and the barrel-receiver 22a defines an external thread section 21a coupling with the internal thread section 11a in the outer surface thereof. The lens module 10a is fixed to the lens holder 20a by screwing the internal thread section 11a into the external thread section 21a.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. A camera module comprising a lens module and a lens holder; the lens module being coupled with the lens holder via thread to form a thread coupling section therebetween, the thread coupling section being filled with a damping oil.

2. The camera module as claimed in the claim 1, wherein the lens module defines an external thread section thereat, the lens holder defines an internal thread section therein, the lens module being installed in the lens holder by screwing the external thread section into the external thread section.

3. The camera module as claimed in the claim 1, wherein the lens module comprises a lens barrel, and the lens holder comprises a cylindrical barrel-receiver, the outer diameter of the lens barrel being essentially equal to the inner diameter of the barrel-receiver; the lens barrel defining an external thread section in the outer surface thereof; the barrel-receiver defining an internal thread section in the inner surface thereof; the lens being installed in the lens holder by screwing the external thread section into the external thread section.

4. The camera module as claimed in the claim 1, wherein the lens module comprises a lens barrel, and the lens holder comprises a cylindrical barrel-receiver; the inner diameter of the lens barrel being essentially equal to the outer diameter of the barrel-receiver; the lens barrel defining an internal thread section in the inner surface thereof; the barrel-receiver defining an external thread section in the outer surface thereof; the lens module being installed to the lens holder by screwing the external thread section into the external thread section.

5. The camera module as claimed in the claim 1, further comprising a light-receiving member disposed within the lens holder.

6. The camera module as claimed in the claim 5, wherein the light-receiving member is selected from a group of charge coupled device and complementary metal oxide semiconductor device.

7. The camera module as claimed in the claim 1, wherein the lens module comprises a barrel and at least one optical member received in the barrel.

8. The camera module as claimed in the claim 7, wherein the at least one optical member is selected from a group consisting of imaging lens and color filter.

9. A camera module comprising:
a holder;
a lens module;
a thread coupling section formed between the lens holder and the lens module configured to attach the lens module to the lens holder, the thread coupling section comprising internal threads defined at one of the lens holder and the lens module, and external threads defined at the other one of the lens holder and the lens module and screwed into the internal threads; and
a damping oil filled in the thread coupling section to seal the thread coupling section.

10. The camera module as claimed in the claim 9, wherein the lens module comprises a barrel and at least one optical member received in the barrel, the barrel being attached to the holder via the thread coupling section.

11. The camera module as claimed in the claim 10, wherein a light-receiving member is installed within the lens holder and aligned with the at least one optical member.

12. The camera module as claimed in the claim 10, wherein the barrel is telescopically installed in the holder, the internal threads being defined at the lens holder, the external threads being defined at the barrel of the lens module.

13. The camera module as claimed in the claim 10, wherein the barrel is telescopically attached to an outer surface of the holder, the external threads being defined at the lens holder, the internal threads being defined at the barrel of the lens module.
